(19) United States
(12) Patent Application Publication
(10) Pub. No.: US 2002/0120528 A1
(43) Pub. Date: Aug. 29, 2002

(54) Method for inserting promotional messages into an internet purchase transaction

(76) Inventor: Curt A. Hutten, Irvine (CA)

Correspondence Address: STETINA BRUNDA GARRED & BRUCKER, KIT M. STETINA, SUITE 250, 75 ENTERPRISE, ALISO VIEJO, CA, 92656, US

(21) Appl. No.: 10/001,150

(22) Filed: Nov. 15, 2001

Related U.S. Application Data
(60) Provisional application No. 60/249,863, filed on Nov. 17, 2000.

(51) Int. Cl. G06F 17/60

(52) U.S. Cl. 705/26

(57) ABSTRACT

The present invention may be regarded as a method for inserting promotional messages into an Internet purchase transaction. The method monitors a customer's path of progression through a web site purchasing process. The method responds to the path selected by interjecting a plurality of promotional messages, each at a selected point in the path.

### CROSS-REFERENCE TO RELATED APPLICATIONS

This application claims the benefit of U.S. Provisional Application 60/249,863, filed Nov. 17, 2000, the entire contents of which are hereby incorporated by reference.

### STATEMENT RE: FEDERALLY SPONSORED RESEARCH/DEVELOPMENT

(Not Applicable)

### BACKGROUND OF THE INVENTION

The present invention relates generally to Internet business (e-commerce) methods and more particularly to a method for inserting promotional messages into an Internet purchase transaction.

Computer systems in general are known. A typical computer system includes a computer, a keyboard, a mouse, and a monitor. Additionally, the computer includes a central processing unit (CPU) and random access memory (RAM) and allows various software programs to be used. Further, the computer system may include a modem, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations. The Internet, which originally came about in the late 1960's, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. Transmission Control Protocol/Internet Protocol (TCP/IP) is one such networking protocol. Computers on a TCP/IP network utilize unique identification codes allowing each computer or host on the Internet to be uniquely identified. Such codes can include an Internet Protocol (IP) number or address and corresponding network and computer names.

Created in 1991, the World-Wide Web (Web, or www) provides access to information on the Internet, allowing a user to navigate Internet resources intuitively, without IP addresses or other specialized knowledge. The Web comprises hundreds of thousands of interconnected “pages” or documents that can be displayed on a user's computer monitor. The web pages are provided by hosts running special servers. Software that runs these web servers is relatively simple and is available on a wide range of computer platforms including personal computers (PCs). Equally available is web browser software used to display web pages, as well as traditional non-web files, on the user's system.

The Web is based on the concept of hypertext and a transfer method known as Hypertext Transfer Protocol (HTTP). HTTP is designed to run primarily over TCP/IP and uses the standard Internet setup where a server issues the data and a client displays or processes the data. One format for information transfer is to create documents using Hypertext Markup Language (HTML). HTML pages are made up of standard text as well as formatting codes indicating how to display the page. A browser reads these codes to display the page. The Web also uses the File Transfer Protocol (FTP) to transmit files between hosts. In particular, a method known as “anonymous FTP” allows a user to receive a file from a server without the server learning the identity of the user.

Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a Uniform Resource Locator (URL). URLs enable the browser to go directly to the associated resource, even if it is on another web server.

In addition to the Internet which allows for general, public retrieval of information, other means of accessing such information exist and are commonly utilized. For example, direct modem connections between two computers, proprietary internal networks within large institutions and organizations, or the like, are equally available and useful means for accessing catalogued information stored in databases.

Some web pages and web sites provide media data. This data can be downloaded or presented as streaming data to a user. Streaming data may be the continuous transmission of data, for example, audio or video data. It is desirable for a provider of such data to transmit such data to a user quickly and reliably. Therefore, a need exists for a system for electronically transmitting electronic media data.

Present Internet merchandising schemes tend to require excessive user interaction, which tends to discourage participation and, ultimately, purchases. Thus, there is a need for delivering “sales pitches” at optimal points during an Internet purchase transaction.

### BRIEF SUMMARY OF THE INVENTION

An aspect of the present invention may be regarded as a method for inserting promotional messages into an Internet purchase transaction. The method monitors a customer's path of progression through a web site purchasing process. The method responds to the path selected by interjecting a plurality of promotional messages, each at a selected point in the path.

One of the promotional messages may be a purchase order. The purchase order may be filled out with customer information. The customer information may be obtained from a server side user profile developed from customer cookies.

A reminder promotional message may be sent to the customer subsequent to the Internet purchase transaction. The reminder promotional message may be in response to a customer request.

An additional promotional message may be interjected when the customer selects a product of interest. A follow-up promotional message may be interjected when the customer requests information about a particular model of the product of interest. A purchase promotional message for a related item may be interjected when the customer requests a purchase of a product of interest.

### BRIEF DESCRIPTION OF THE DRAWINGS

These, as well as other features of the present invention, will become apparent upon reference to the drawings, wherein:

FIG. 1 illustrates a method of inserting promotional messages into an Internet purchase transaction.

### DETAILED DESCRIPTION OF THE INVENTION

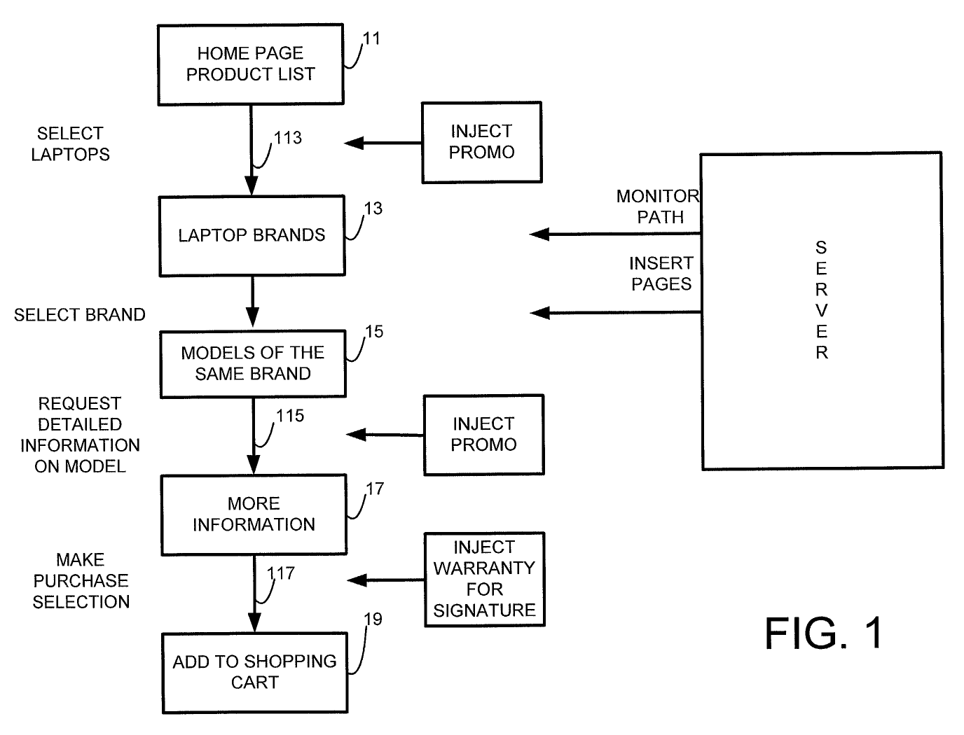

An exemplary Internet purchasing transaction is illustrated in FIG. 1. Initially, a potential customer downloads a home page containing a list of products 11. The customer then selects (for example, using a mouse), a particular category of products of interest, in this case laptop computers, resulting in downloading of a web page showing a number of brands of laptop computers 13. The next customer selection operation is a brand selection, e.g., IBM® which results in the download and display of a web page showing models for the selected brand 15, e.g., IBM® models. The next selection operations respectively select information on a particular IBM® laptop computer which results in the download and display of a web page having further information about the selected product 17. The particular product (e.g., laptop computer) is added to a so-called “shopping cart” 19.

In exemplary embodiments, the customer's movements from one link to the next are tracked from the server side via a server side cookie. The knowledge of the customer's movements are used to present sales promotion information at appropriate times, designed to maximize the probability of causing a purchase while at the same time minimizing the possibility that the user may become irritated by interruptions. Minimizing irritation typically entails appropriate spacing and timing of the interjection of promotional material.

An example of the method will now be set forth in conjunction with FIG. 1. This particular example illustrates an effort to sell an extended warranty to the potential laptop purchaser. Thus, when the user selects “laptop” as the product of interest, the server momentarily interjects a page in path 113 which presents an initial sales pitch for extended warranties, e.g., “Extended warranties available for this item.” As the server monitors the customer's path selection, it notes the user's request for information on a particular model of IBM® computer and momentarily interjects another message in path 115, before the information on the particular model is displayed to the user. This message may state, for example, “We feature the Best Extended Warranty Policy Available on IBM Laptops.” Then, upon selection of the particular product for adding to the shopping cart, the server causes display of a warranty policy completely filled out with the customer's name 117. The customer information necessary to fill out the form is obtained from a user profile developed by server side “cookying” of the customer. The filled-out warranty policy includes a “Just Sign Here” selection box to permit the customer to easily “sign up” for the extended warranty. Just this step in itself considerably facilitates the sales process by eliminating the conventional necessity to check a box and go to a jump page to view the warranty, which then must additionally be filled out with customer name, etc. Another readily implementable feature is to provide a box which may be clicked on to cause a reminder to be sent from the server to the customer later on in the event that the customer wants time to consider whether to purchase the extended warranty.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method of facilitating Internet sales comprising:
monitoring a customer's path of progression through a web site purchasing process; and
responding to the path selected to interject a plurality of promotional messages, each at a selected point in the path.

2. The method of claim 1, wherein a respective one of the promotional messages comprises a purchase order.

3. The method of claim 2, wherein the purchase order is a warranty purchase order.

4. The method of claim 2, wherein the purchase order is filled out with customer information.

5. The method of claim 4, wherein the customer information is obtained from a server side user profile developed from customer cookies.

6. The method of claim 2, further comprising providing a reminder promotional message subsequent to the customer's path of progression through the web site purchasing process.

7. The method of claim 6, wherein the reminder promotional message is provided in response to a request by the customer.

8. The method of claim 1, wherein an initial promotional message is interjected when the customer selects a product of interest.

9. The method of claim 8, wherein a follow-up promotional message is interjected when the customer requests information about a particular model of the product of interest.

10. The method of claim 9, wherein a purchase promotional message for a related item is interjected when the customer requests a purchase of the particular model of the product of interest.

11. The method of claim 8, wherein a purchase promotional message for a related item is interjected when the customer requests a purchase of the product of interest.

12. A system for facilitating Internet sales comprising:
a server configured to communicate with a plurality of customer computers over a network, the server comprising:
a monitor module configured to monitor a customer's path of progression through a web site purchasing process; and
an interjection module configured to interject a plurality of promotional messages in response to the customer's path of progression through the web site purchasing process.

13. The system of claim 12, wherein a respective one of the promotional messages comprises a purchase order.

14. The system of claim 13, wherein the purchase order is a warranty purchase order.

15. The system of claim 13, wherein the purchase order is filled out with customer information.

16. The system of claim 15, wherein the customer information is obtained from a server side user profile developed from customer cookies.

17. The system of claim 12, wherein the server further comprises a reminder module configured to transmit a reminder promotional message to a respective customer computer subsequent to the customer's path of progression through the web site purchasing process.
